(19) United States
(12) Patent Application Publication
(10) Pub. No.: US 2012/0127139 A1
(43) Pub. Date: May 24, 2012

(54) IN-VEHICLE INFORMATION PROCESSING DEVICE

(75) Inventors: Katsuro Hayami, Tokyo (JP); Masatsugu Norimoto, Tokyo (JP)

(73) Assignee: Mitsubishi Electric Corporation, Tokyo (JP)

(21) Appl. No.: 13/388,237

(22) PCT Filed: Sep. 30, 2009
(86) PCT No.: PCT/JP2009/005036

§ 371 Date: Jan. 31, 2012

(51) Int. Cl. G09G 5/00

(52) U.S. Cl. 345/204

(57) ABSTRACT

When a request to execute the same Java application program as a Java (registered trademark, omitted hereafter) application program currently being executed, the Java application program is deployed into a work area of a RAM 4 and the plurality of Java applications are executed simultaneously. A process result of the Java application program executed according to operation information is displayed on one of display units 8-1 and 8-2 which corresponds to an operation unit via which the operation information is inputted.

### FIELD OF THE INVENTION

The present invention relates to an in-vehicle information processing device which executes an application program.

### BACKGROUND OF THE INVENTION

For example, patent reference 1 discloses an in-vehicle information processing device which executes a Java (a registered trademark, omitted hereafter) application. This device is provided with a navigation function and constructs the function of a part of both a program for performing route guiding and a navigation program by using Java applications. Using this construction, the in-vehicle information processing device implements a display of display information about the route guiding and display information about the navigation on the display screen of a single display unit while superimposing them.

Furthermore, patent reference 2 discloses an information processing device which executes a Java application. This device determines a combination of a screen for display information which the device creates by executing a native application and a screen for display information which the device creates by executing a Java application according to a mode managed thereby, and displays the combination on a display. As a result, the information processing device can improve the ease of use of switching between the pieces of display information which the device creates by executing both the applications.

In addition, in a device described by patent reference 3, a program related to each function of navigation consists of a Java application. Because a Java application operates on a Java virtual machine independently on the hardware of any device, each function of navigation can be changed independently.

Because a conventional device is constructed in such a way that a part of the functions which the device has is implemented by Java applications, a function change or the like can be easily made to the device.

A problem is however that such a conventional device mounted in a vehicle cannot execute one Java application simultaneously and independently according to operations separately done by a plurality of users riding in the vehicle.

The present invention is made in order to solve the above-mentioned problem, and it is therefore an object of the present invention to provide an in-vehicle information processing device that can execute one Java application simultaneously and independently according to operations done by a plurality of users.

### RELATED ART DOCUMENT

### Patent Reference

Patent reference 1: Japanese Unexamined Patent Application Publication No. 2007-163210
Patent reference 2: Japanese Unexamined Patent Application Publication No. 2007-86859
Patent reference 3: Japanese Unexamined Patent Application Publication No. 2007-128432

### SUMMARY OF THE INVENTION

In accordance with the present invention, there is provided an in-vehicle information processing device including: a program storing unit for storing application programs; a storage unit having work areas into which the application programs are deployed; a program replicating and deploying unit for replicating an application program stored in the program storing unit, and deploying the application program into a work area of the storage unit; a program control unit for executing the application program which is deployed into the work area of the storage unit by the program replicating and deploying unit; a plurality of operation units each for inputting an operation from outside the in-vehicle information processing device; a plurality of display units corresponding to the plurality of operation units, respectively; and an individual operation and display control unit for determining an operation unit on which an operation is performed from among the plurality of operation units while outputting information showing operation information inputted by the above-mentioned operation unit to the program control unit, and for controlling a display of a process result acquired by the application program executed by the program control unit on the display unit, in which when a request to execute the same application program as an application program which has been being executed in response to operation information inputted by one of the plurality of operation units is made via another operation unit different from the above-mentioned operation unit, the program replicating and deploying unit replicates the same application program stored in the program storing unit, and deploys the replica of the application program into another work area of the storage unit, the program control unit has a function of simultaneously executing a plurality of application programs, and executes the same application program deployed into each of the work areas of the storage unit according to the operation information inputted by each of the operation units, and according to the operation information inputted by the operation unit, the individual operation and display control unit displays a process result acquired by the application program executed by the program control unit on the display unit corresponding to the operation unit via which the above-mentioned operation information is inputted.

According to the present invention, when a request to execute the same application program as an application program which has been being executed in response to operation information inputted by one of the plurality of operation units is made via another operation unit different from the above-mentioned operation unit, the program replicating and deploying unit replicates the same application program stored in the program storing unit, and deploys the replica of the application program into another work area of the storage unit, the program control unit has a function of simultaneously executing a plurality of application programs, and executes the same application program deployed into each of the work areas of the storage unit according to the operation information inputted by each of the operation units, and according to the operation information inputted by the operation unit, the individual operation and display control unit displays a process result acquired by the application program executed by the program control unit on the display unit corresponding to the operation unit via which the above-mentioned operation information is inputted.

Because the in-vehicle information processing device is constructed in this way, there is provided an advantage of being able to perform information processes for a single Java application program simultaneously and independently in response to operations done by a plurality of users.

### BRIEF DESCRIPTION OF THE FIGURES

FIG. 1 is a view showing the hardware configuration of an in-vehicle information processing device in accordance with Embodiment 1 of the present invention;

FIG. 2 is a block diagram showing the function configuration of the in-vehicle information processing device in accordance with Embodiment 1;

FIG. 3 is a flow chart showing a flow of an operation (a process of making a program available) performed by the in-vehicle information processing device in accordance with Embodiment 1; and

FIG. 4 is a flow chart showing a flow of an operation (an executing process) performed by the in-vehicle information processing device in accordance with Embodiment 1.

### EMBODIMENTS OF THE INVENTION

Hereafter, in order to explain this invention in greater detail, the preferred embodiments of the present invention will be described with reference to the accompanying drawings. Embodiment 1.

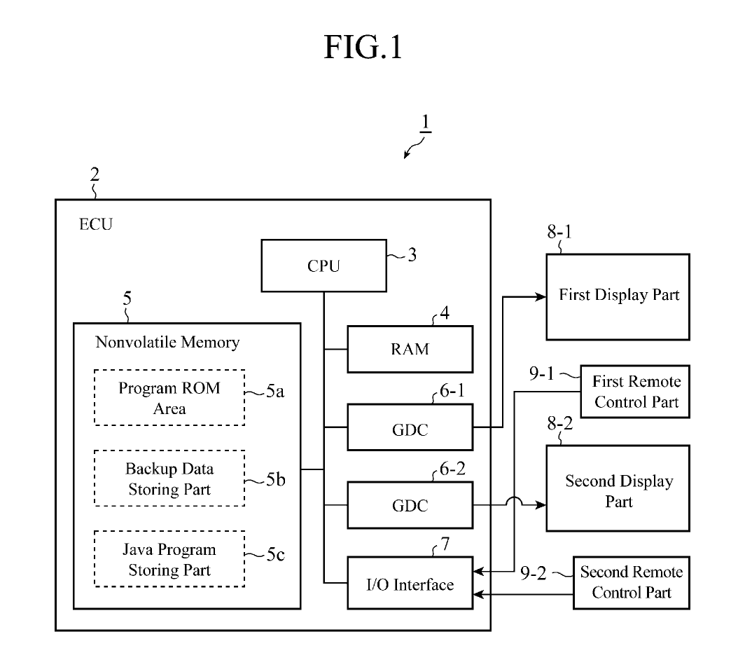

FIG. 1 is a view showing the hardware configuration of an in-vehicle information processing device in accordance with Embodiment 1 of the present invention. A structure for carrying out arithmetic processing in the in-vehicle information processing device 1 of Embodiment 1 is constructed in an ECU (Electronic Control Unit) 2 disposed in a vehicle. The ECU 2 is provided with a CPU 3 which performs various arithmetic processes, a RAM (Random Access Memory) 4 used for the arithmetic processes performed by the CPU 3, a non-volatile memory 5, GDCs (Graphic Display Controllers) 6-1 and 6-2, and an I/O interface 7.

The non-volatile memory 5 is a storage unit for storing a program executed by the CPU 3, backup data, etc., and has a program ROM (Read Only Memory) area 5a, a backup data storing part 5b, and a Java program storing part 5c. The program ROM area 5a is a nonvolatile read-only storage area for storing various programs each of which is performed by the CPU 3, and fixed data. The backup data storing part 5b is a storage area for storing a backup of data acquired through an arithmetic process performed by the CPU 3. The Java program storing part 5c is a storage area for storing a Java application program.

The GDC 6-1 is a component for controlling a screen display of a first display part 8-1. The GDC 6-2 is a component for controlling a screen display of a second display part 8-2. The I/O interface 7 relays an exchange of information between the ECU 2, and each of a first remote control part 9-1 and a second remote control part 9-2. An operational input done by a user using one of the remote control parts 9-1 and 9-2 which are input units is sent to the ECU 2 via the I/O interface 7. Furthermore, a calculation result acquired by the ECU 2 is presented for the user with the result being displayed on the screen of the display part 8-1 or 8-2 by the GDC 6-1 or 6-2.

In this Embodiment 1, because a case in which the single ECU 2 carries out display control of calculation results in response to operational inputs done by two users is assumed, the in-vehicle information processing device has the two sets of GDC, display part, and remote control part.

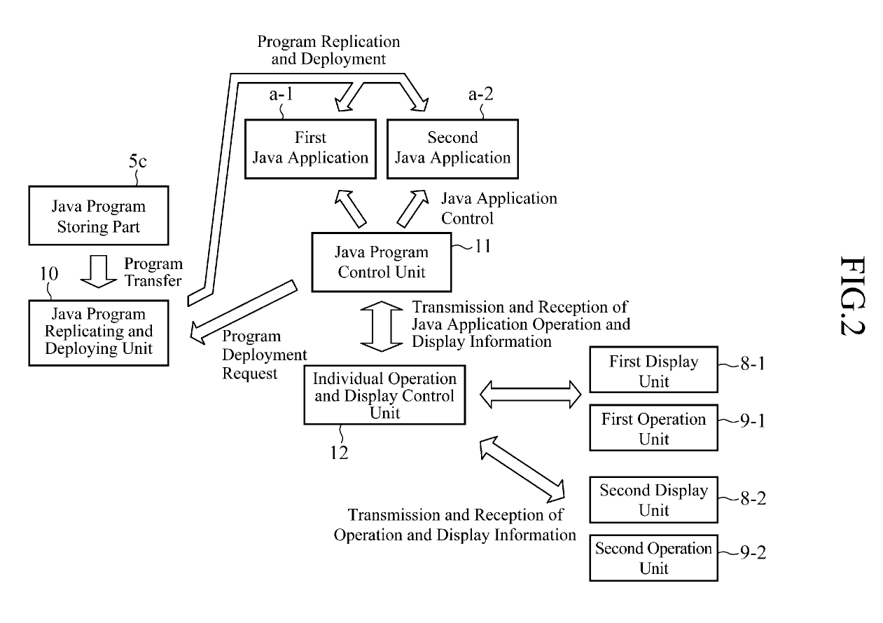

FIG. 2 is a block diagram showing the function configuration of the vehicle-mounted information processing device in accordance with Embodiment 1. In FIG. 2, a first display unit 8-1 corresponds to the first display part 8-1 shown in FIG. 1, and a second display unit 8-2 corresponds to the second display part 8-2 shown in FIG. 1. The display units 8-1 and 8-2 are disposed on a side of a rear seat and on a side of a front seat in the vehicle, for example, and can display different contents for two users, respectively. A first operation unit 9-1 corresponds to the first remote control part 9-1 shown in FIG. 1, and a second operation unit 9-2 corresponds to the second remote control part 9-2 shown in FIG. 1. The two users can simultaneously perform their respective desired operations by using the operation units 9-1 and 9-2.

A Java program replicating and deploying unit 10 is a component for reading a Java application program from the Java program storing part 5c and deploying the Java application program into a work area of the RAM 4 in response to a request from a Java program control unit 11. At this time, when receiving a request to execute the same Java application (e.g. a first Java application a-1) from a user, the Java program replicating and deploying unit 10 reads the application program of this Java application from the Java program storing part 5c to replicate this application program, and deploys the replicated Java application program (e.g. a second Java application a-2) into another work area of the RAM 4.

The Java program control unit 11 is a component for starting the Java applications a-1 and a-2 deployed into the work areas of the RAM 4 in response to the requests inputted by the users using the operation units 9-1 and 9-2, and for controlling operations according to the Java applications a-1 and a-2. Concretely, the Java program control unit 11 functions as a multitasking virtual machine, for example, and two virtual machines simultaneously execute the Java applications a-1 and a-2 which are respectively deployed into the different work areas of the RAM 4 on a single process.

Although the virtual machines share a run time, a loaded code, and a native code which is a JIT (Just In Time) compile result, each of the virtual machines performs the same Java application. However, data, compile results, etc. which cause trouble in the operations of both the virtual machines when they are shared between the virtual machines are used while the data, the compile results and so on are distinguished from each other by using a difference in the work area into which they are deployed, or the like.

An individual operation and display control unit 12 is a component for controlling a display process performed by each of the display units 8-1 and 8-2 according to a command from the Java program control unit 11, and for acquiring operation information inputted through each of the operation units 9-1 and 9-2, and transmitting the operation information to the Java program control unit 11. The individual operation and display control unit 12 is implemented by the structure related to the arithmetic processing which consists of the CPU 3, the GDCs 6-1 and 6-2, and the I/O interface 7 which are shown in FIG. 1.

The CPU 3 shown in FIG. 1 reads a processing program which provides functions according to the scope of the present invention from the program ROM area 5a and then executes the processing program to implement the Java program replicating and deploying unit 10, the Java program control unit 11, and the individual operation and display control unit 12 as a concrete means in which software and hardware work in cooperation with each other.

Next, the operation of the in-vehicle information processing device will be explained.

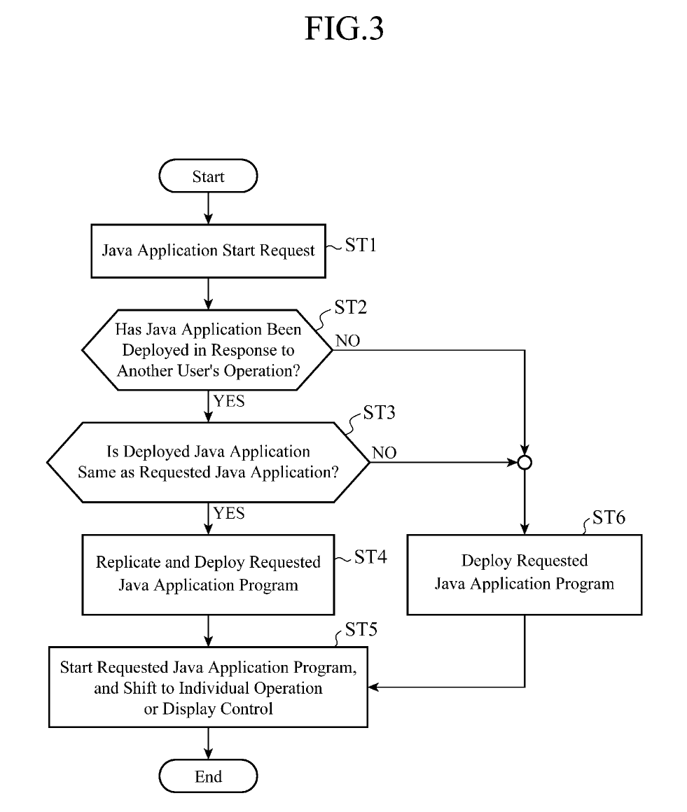

FIG. 3 is a flow chart showing a flow of an operation performed by the in-vehicle information processing device in accordance with Embodiment 1, and shows a process at the time when a plurality of users simultaneously make a request to use an identical Java application.

First, when a Java application start request is made by a user by using at least one of the operation units 9-1 and 9-2 (step ST1), this start request is transmitted to the Java program control unit 11 via the individual operation and display control unit 12.

When receiving the Java application start request, the Java program control unit 11 determines whether it has already started a Java application in response to an operation done by another user (step ST2). In this case, the Java program control unit determines whether or not a Java application program has been deployed into a work area of the RAM 4.

When a Java application has been already started in response to an operation done by another user (if YES in step ST2), the Java program control unit 11 determines whether the Java application whose program has been deployed into a work area of RAM 4 and has been being executed is the same as the Java application for which the start request is made this time (step ST3).

When the Java application currently being executed is the same as the Java application for which the start request is made this time (if YES in step ST3), the Java program control unit 11 makes a request of the Java program replicating and deploying unit 10 to replicate and deploy the Java application program.

When receiving the request from the Java program control unit 11, the Java program replicating and deploying unit 10 identifies the Java application program meeting the request from the Java application programs stored in the Java program storing part 5c.

After that, Java program replicating and deploying unit 10 creates a replica of the identified Java application program and reads this replica from the Java program storing part 5c, and deploys the replica into a work area (a work area different from that into which the already-started Java application is deployed) of the RAM 4 (step ST4).

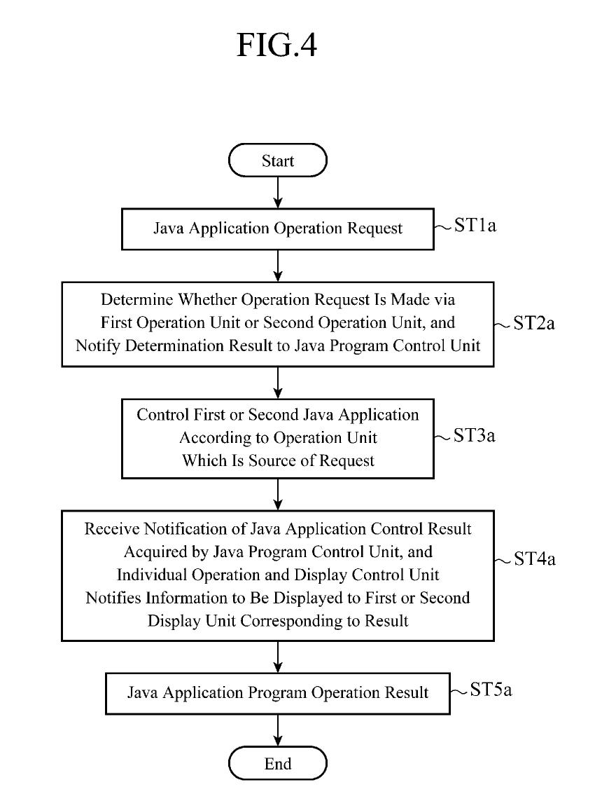

The Java program control unit 11 then starts the Java application program which is the replica deployed into the work area of the RAM 4, and performs a process using the individual operation and display control unit 12 which will be mentioned later with reference to FIG. 4 (step ST5).

In contrast, when any Java application has not been started in response to an operation done by another user when the Java application start request is made (if NO in step ST2), or when a Java application different from the Java application for which the start request is made has been already started (if NO in step ST3), the Java program control unit 11 makes a request of Java program replicating and deploying unit 10 to replicate and deploy the application program of the Java application for which the start request is made this time.

The Java program replicating and deploying unit 10 replicates the program of the Java application meeting the request, reads this replica of the program from the Java program storing part 5c, and then deploys the replica into a work area of the RAM 4 (step ST6). After that, the in-vehicle information processing device shifts to the above-mentioned process of step ST5.

FIG. 4 is a flow chart showing a flow of an operation performed by the vehicle-mounted information processing device in accordance with Embodiment 1, and shows a process at the time when a plurality of users simultaneously perform operations for making the in-vehicle information processing device execute an identical Java application. First, when a Java application operation request is made by using the first operation unit 9-1 or the second operation unit 9-2 (step ST1a), the individual operation and display control unit 12 determines from which one of the first and second operation units 9-1 and 9-2 the Java application operation request has been transmitted, and transmits operation information showing the above-mentioned request operation, as well as the result of this determination, to the Java program control unit 11 (step ST2a).

On the basis of the information transmitted from the individual operation and display control unit 12, the Java program control unit 11 executes the Java application corresponding to the operation unit 9-1 or 9-2 which is the source of the request, among the Java programs deployed into the work areas of the RAM 4 in the process which is explained with reference to FIG. 3, to perform operation control according to the operation request (step ST3a).

The result of this control is transmitted from the Java program control unit 11 to the individual operation and display control unit 12. The individual operation and display control unit 12 notifies information to be displayed according to this control result to the display unit 8-1 or 8-2 corresponding to the operation unit which is the source of the request (step ST4a). As a result, the display unit 8-1 or 8-2 displays the information to be displayed according to the control result for which the operation request has been made on the screen thereof (step ST5a).

As mentioned above, in the in-vehicle information processing device in accordance with this Embodiment 1, when a request to execute the same Java application program as a Java application program which has been being executed in response to operation information inputted by one of the operation units 9-1 and 9-2 is made via another operation unit different from the above-mentioned operation unit, the Java program replicating and deploying unit 10 replicates the Java application program stored in the Java program storing part 5c, and deploys the replica of the Java application program into another work area of the RAM 4, the Java program control unit 11 has a function of simultaneously executing a plurality of Java application programs, and executes the same Java application program deployed into each work area of the RAM 4 according to the operation information inputted by each of the operation units 9-1 and 9-2, and, according to the operation information inputted by each of the operation units, the individual operation and display control unit 12 displays the process result acquired by the Java application program executed by the Java program control unit on the display unit corresponding to the operation unit via which the operation information is inputted.

Because the in-vehicle information processing device is constructed in this way, the in-vehicle information processing device can perform information processes for a single Java application program simultaneously and independently in response to operations done by a plurality of users.

Furthermore, although in above-mentioned Embodiment 1 the structure in which different display units are disposed as the ones respectively corresponding to the operation units 9-1 and 9-2, the display units respectively corresponding to the operation units 9-1 and 9-2 can be alternatively constructed by using a single display unit having a split view function of providing a different screen according to the direction along which each user views the screen of this single display unit or by splitting the screen into plural regions.

In addition, although in above-mentioned Embodiment 1 the case in which Java application programs are stored in the Java program storing part 5c of the non-volatile memory 5 is shown, the in-vehicle information processing device can be constructed in such a way as to download a Java application program thereinto via a memory card, an optical disc, the Internet, or the like to write this new application program therein.

Furthermore, although in above-mentioned Embodiment 1 the case in which a Java application for which a start request is made by the operation unit 9-1 or 9-2 is operated as a Java application corresponding to the operation unit 9-1 or 9-2, the above-mentioned corresponding Java applications can be interchanged according to an operation request made by using the operation unit 9-1 or 9-2.

### INDUSTRIAL APPLICABILITY

Because the in-vehicle information processing device in accordance with the present invention can perform information processes for one Java application program simultaneously and independently in response to operations done by a plurality of users, the in-vehicle information processing device in accordance with the present invention is suitable for use as an in-vehicle display unit mounted in a vehicle in which display monitors are respectively disposed for a front seat and a rear seat.

1. An in-vehicle information processing device comprising:
a program storing unit for storing application programs;
a storage unit having work areas into which said application programs are deployed;
a program replicating and deploying unit for replicating an application program stored in said program storing unit, and deploying the application program into a work area of said storage unit;
a program control unit for executing the application program which is deployed into the work area of said storage unit by said program replicating and deploying unit;
a plurality of operation units each for inputting an operation from outside said in-vehicle information processing device;
a plurality of display units corresponding to said plurality of operation units, respectively; and
an individual operation and display control unit for determining an operation unit on which an operation is performed from among said plurality of operation units while outputting information showing operation information inputted by said operation unit to said program control unit, and for controlling a display of a process result acquired by the application program executed by said program control unit on said display unit, wherein
when a request to execute a same application program as an application program which has been being executed in response to operation information inputted by one of said plurality of operation units is made via another operation unit different from said operation unit, said program replicating and deploying unit replicates said same application program stored in said program storing unit, and deploys the replica of the application program into another work area of said storage unit, said program control unit has a function of simultaneously executing a plurality of application programs, and executes the same application program deployed into each of the work areas of said storage unit according to the operation information inputted by each of said operation units, and, according to the operation information inputted by said operation unit, said individual operation and display control unit displays a process result acquired by the application program executed by said program control unit on said display unit corresponding to said operation unit via which said operation information is inputted.

2. An in-vehicle information processing device comprising:
a program storing unit for storing application programs;
a storage unit having work areas into which said application programs are deployed;
a program replicating and deploying unit for replicating an application program stored in said program storing unit, and deploying the application program into a work area of said storage unit;
a program control unit for executing the application program which is deployed into the work area of said storage unit by said program replicating and deploying unit;
a plurality of operation units each for inputting an operation from outside said in-vehicle information processing device;
a display unit having a plurality of screens respectively corresponding to said plurality of operation units;
an individual operation and display control unit for determining an operation unit on which an operation is performed from among said plurality of operation units while outputting information showing operation information inputted by said operation unit to said program control unit, and for controlling a display of a process result acquired by the application program executed by said program control unit on said display unit, wherein
when a request to execute a same application program as an application program which has been being executed in response to operation information inputted by one of said plurality of operation units is made via another operation unit different from said operation unit, said program replicating and deploying unit replicates said same application program stored in said program storing unit, and deploys the replica of the application program into another work area of said storage unit, said program control unit has a function of simultaneously executing a plurality of application programs, and executes the same application program deployed into each of the work areas of said storage unit according to the operation information inputted by each of said operation units, and, according to the operation information inputted by said operation unit, said individual operation and display control unit displays a process result acquired by the application program executed by said program control unit on one of said screens of said display unit corresponding to said operation unit via which said operation information is inputted.

3. The in-vehicle information processing device according to claim 1, wherein the application programs run on a virtual machine.

4. The in-vehicle information processing device according to claim 3, wherein the application programs which run on the virtual machine are Java (registered trademark) application programs.

5. The in-vehicle information processing device according to claim 2, wherein the display unit has a split view function of providing a different screen according to a direction along which a user views the display unit, and the plurality of screens which said display part has are different screens which are provided for said user according to the direction along which said user views the display unit, respectively.

6. The in-vehicle information processing device according to claim 2, wherein the display unit has a function of dividing a single screen thereof into a plurality of small screens, and said plurality of screens which said display unit has are the small screens into which said single screen is divided, respectively.

7. The in-vehicle information processing device according to claim 1, wherein the program storing unit is a storage unit into which a program inputted from outside the in-vehicle information processing device via a memory card or communications can be rewritten.

8. The in-vehicle information processing device according to claim 1, wherein the program control unit interchanges contents displayed on the plurality of display units according to a user's operation.
